(19) United States
(12) Patent Application Publication
(10) Pub. No.: US 2008/0123955 A1
(43) Pub. Date: May 29, 2008

(54) METHOD FOR ESTIMATING BOUNDARY OF VIDEO SEGMENT IN VIDEO STREAMS

(76) Inventors: Chia-Hung Yeh, Tai-Nan City (TW); Hsuan-Huei Shih, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/564,833

(22) Filed: Nov. 29, 2006

(51) Int. Cl. G06K 9/34

(52) U.S. Cl. 382/173

(57) ABSTRACT

A method for estimating a boundary of a video segment transmitted via an input multimedia stream includes utilizing a sliding window to calculate shots occurring in the input video stream for generating a plurality of shot numbers respectively, and estimating the boundary according to the shot numbers and a predetermined threshold value.

### BACKGROUND OF THE INVENTION

1. Field of the Invention

The present invention relates to a method for estimating a boundary (i.e., a starting boundary or an ending boundary) of a video segment transmitted via an input multimedia stream, and more particularly, to a method for estimating a boundary of a commercial segment in the input multimedia stream by utilizing a sliding window to generate a plurality of shot numbers and comparing the shot number with a predetermined threshold.

2. Description of the Prior Art

Recently, a method for estimating a video segment has become more and more important. The reason is that a video program such as a television TV program can be stored in a storage device in advance but video segments not related to the TV program, commercial segments for example, are stored simultaneously. Usually people do not like to view commercial segments and will hope to enjoy their favorite TV program without interruption. Therefore a method for identifying a commercial segment is needed. Additionally, it is also important for video content analysis to identify commercial segments. Commercial segments can be removed before video content analysis such that an accurate analysis result is achieved. Conventional methods for identifying commercial segments vary in different countries since they depend on rules of different countries. For example, in America or in Germany, a black frame is forced to play before starting a commercial segment or after a commercial segment is finished. Therefore, detecting a black frame in the video program means a TV program segment is just finished and a commercial segment will be started in the next moment, or a commercial segment is just finished and a TV program segment will be started in the next moment. This helps when estimating a commercial segment. However, in Taiwan or other areas, no black frame is forced to play before starting a commercial segment or after finishing the commercial segment. Under this condition, estimating a commercial segment becomes complicated and difficult. Therefore, there is a need for a new and effective method to estimate a commercial segment when there is not any black frame presented before or after the commercial segment.

### SUMMARY OF THE INVENTION

Therefore one of the objectives of the present invention is to provide a method for estimating a boundary of a video segment (for example a commercial segment) according to camera shots occurring and a predetermined threshold value, to solve this problem.

According to the claimed invention, a method for estimating a boundary of a video segment transmitted via an input multimedia stream is disclosed. The method comprises utilizing a sliding window to calculate shots occurring in the input video stream for generating a plurality of shot numbers respectively, and estimating the boundary according to the shot numbers and a predetermined threshold value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating an embodiment of a method for estimating a boundary of a video segment according to the present invention.

FIG. 2 is a continued flowchart of FIG. 1.

FIG. 3 is a diagram of an example illustrating the method for estimating the boundary of the video segment.

### DETAILED DESCRIPTION

In a case where no black frame is presented for reference in detecting a commercial segment between two TV program segments, the present invention utilizes a characteristic difference between the TV program contents and the commercial segment to achieve the goal of estimating a boundary of the commercial segment. One major characteristic difference is that a video shot occurring/shot changing frequency (i.e., different camera angle shots) in the TV program and that in the commercial segment differ. Because commercial segments are usually very fancy to impress people, the shot occurring/shot changing frequency is higher than that of TV program contents. An embodiment of a commercial boundary detection of the present invention is described below.

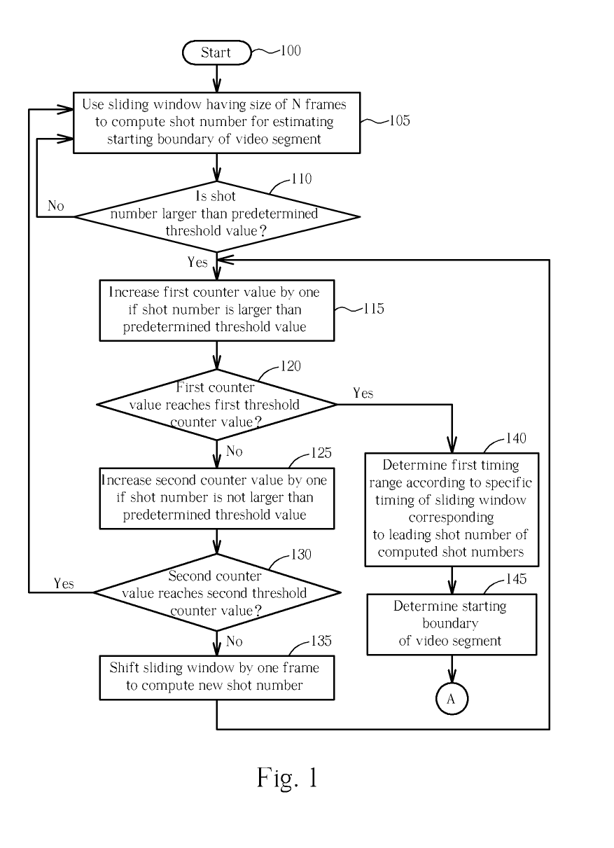

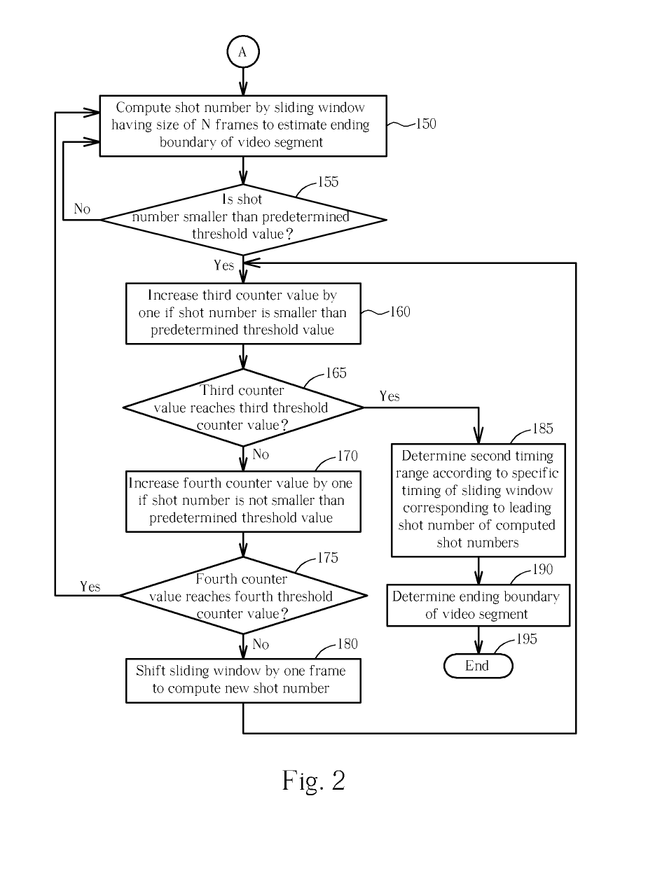

Please refer to FIG. 1 in conjunction with FIG. 2. FIG. 1 is a flowchart illustrating an embodiment of a method for estimating a boundary of a video segment according to the present invention. FIG. 2 is a continued flowchart of FIG. 1. In this embodiment, the video segment is to be identified from an input multimedia stream. For example, the input multimedia stream is transmitted via a TV channel, and the video segment is a commercial segment. However, the present invention is not limited to this example. That is, other alternative designs obeying the spirit of the present invention fall in the scope of the present invention. The method for estimating the boundary of the video segment is to utilize a sliding window having a size of N frames to calculate camera shots occurring in the input video stream for generating a plurality of shot numbers respectively. In other words, the sliding window is used for deriving a total number of shots occurring in N frames according to the input video stream, where the sliding window is shifted frame by frame. Each time the sliding window is shifted by one frame, a new shot number is computed. Therefore, pluralities of shot numbers are generated along with the moving of the sliding window. Since common commercial segments are usually very fancy to impress people, a generated shot number related to a corresponding sliding window is usually high if part of a commercial segment enters the sliding window. Therefore, the starting boundary/ending boundary of the video segment (i.e. a commercial segment) can be estimated according to the statistics of the computed shot numbers and predetermined threshold value(s).

The method for estimating the boundary of the video segment is started (Step 100) and first the starting boundary of the commercial segment is to be estimated. A shot number is computed using the sliding window (which has a size of N frames) (Step 105). After the shot number is generated, the shot number is checked to see if it is larger than the predetermined threshold value (Step 110). In this embodiment, a value equal to 5 is chosen as the predetermined threshold value and a value equal to 300 is chosen as the size of the sliding window N. However, this is not meant to be a limitation of the present invention. Therefore, if the shot change number in 300 frames (i.e. 10 seconds) is higher than 5, it is possible that part of a commercial segment may exist within these frames, and the flow then proceeds to Step 115. However, if the shot number is not larger than the predetermined threshold value (i.e. 5), the flow goes back to Step 105 and the sliding window is shifted one frame to compute a new shot number.

A first counter value (please note that its initial value is zero in this embodiment) will be incremented by one if the computed shot number is identified to be larger than the predetermined threshold value (i.e. 5) 115). In Step 120, the first counter value will be checked if the first counter value reaches the first threshold counter value. In this embodiment, the first threshold counter value is set by a value equal to 50; however, this is not meant to be a limitation of the present invention. When the first counter value does not reach the first threshold counter value (i.e. 50), the flow goes to Step 125. In Step 125, a second counter value (please note that its initial value is also zero in this embodiment) will be incremented by one if the shot number is not larger than the predetermined threshold value (i.e. 5). Continuously, the second counter value is further checked to see if it reaches the second threshold counter value (e.g. 5) (Step 130). Once the second counter value reaches the second threshold counter value (e.g. 5), both the first counter value and second counter value will be reset to their respective initial values and the flow goes back to Step 105. If the second counter value does not reach the second threshold counter value (e.g. 5), the sliding window is shifted by one frame to compute a new shot number (Step 135) and Step 115 and Step 120 are performed again.

If the first counter value reaches the first threshold counter value (i.e. 50), this implies that there are 50 shot numbers greater than the predetermined threshold value (i.e., 5) and a first timing range covering candidate timings of the starting boundary of the commercial segment is determined according to a specific timing of the sliding window corresponding to a leading shot number of these 50 computed shot numbers (Step 140). In this embodiment, the specific timing is chosen to be an ending boundary of the sliding window corresponding to the leading shot number since part of a TV program segment may still fall within the sliding window. Therefore, by using this ending boundary of the sliding window to determine the first timing range covering candidate timings of the starting boundary of the commercial segment, this embodiment can avoid a part of the TV program content from erroneously being deleted when a commercial segment delimited by the “estimated” starting boundary and “estimated” ending boundary is removed during a video editing operation. However, the above selection rule is not meant to be a limitation of the present invention. In general, the first timing range is determined to be within a neighborhood of the ending boundary of the sliding window corresponding to the leading shot number. As usual, the ending boundary of the sliding window is located at the center of the determined first timing range. For example, the first timing range comprises the ending boundary of the sliding window, 100 frame timings in front of the ending boundary of the sliding window, and 100 frame timings behind the ending boundary of the sliding window. However, the setting of 100 frame timings is not meant to be a limitation of the present invention. After the first timing range is determined, the starting boundary of the video segment (e.g., a commercial segment) is determined next (Step 145). For example, the starting boundary of the video segment is determined as a target timing (compared to the last frame timing) having a maximum luminance difference value corresponding to frames in the first timing range. In other embodiments, an audio discontinuity, for example a discontinuousness section of the volume, between a first specific frame and a second specific frame in the first timing range can also be utilized for determining the starting boundary of the video segment. In this situation, a frame timing corresponding to the second specific frame next to the first specific frame is determined to be the starting boundary of the video segment.

After the starting boundary of the video segment (i.e. the commercial segment) is determined, an ending boundary of the video segment is to be estimated. As to estimating the ending boundary (i.e. an end of the commercial segment), a shot number is computed by the sliding window having the size of 300 frames (Step 150). After the shot number is generated, the computed shot number is checked to see if it is smaller than the predetermined threshold value (i.e. 5) (Step 155). That is, if the shot number in 300 frames (i.e. 10 seconds) is smaller than 5, it is possible that part of a commercial segment may not exist within these frames, and the flow proceeds to Step 160; however, if the shot number is not smaller than the predetermined threshold value (i.e. 5), the flow goes back to Step 150 and the sliding window is shifted by one frame to compute a new shot number.

When estimating the ending boundary, a third counter value (please note that its initial value is also zero in this embodiment) will be incremented by one if the shot number is smaller than the predetermined threshold value (i.e. 5) (Step 160). In Step 165, the third counter value will be checked to see if it reaches a third threshold counter value. In this embodiment, a value equal to 1000 is set to the third threshold counter value; however, this is not meant to be a limitation of the present invention. When the third counter value does not reach the third threshold counter value (i.e. 1000), the flow goes to Step 170. In Step 170, a fourth counter value (please note that its initial value is also zero in this embodiment) will be incremented by one if the shot number is not smaller than the predetermined threshold value (i.e. 5). Continuously, the fourth counter value is checked to see if it reaches the fourth threshold counter value (e.g. 30) (Step 175). Once the fourth counter value reaches the fourth threshold counter value (e.g. 30), both the third counter value and fourth counter value will be reset to their respective initial values and the flow goes back to Step 150. If the fourth counter value does not reach the fourth threshold counter value (e.g. 30), the sliding window will be shifted by one frame to compute a new shot number (Step 180) and Steps 160 and 165 are performed again.

If the third counter value reaches the third threshold counter value (i.e. 1000), it implies that there are 1000 shot numbers smaller than the predetermined threshold value (i.e. 5) and a second timing range covering candidate timings of the ending boundary of the video segment is determined according to a specific timing of the sliding window corresponding to a leading shot number of these 1000 computed shot numbers (Step 185). In this embodiment, the specific timing is chosen to be a starting boundary of the sliding window corresponding to the leading shot number since part of a TV program segment may still fall within the sliding window. Therefore, by using this starting boundary of the sliding window to determine the second timing range covering candidate timings of the ending boundary of the commercial segment, this embodiment can avoid part of the TV program contents from being erroneously deleted when a commercial segment delimited by the “estimated” starting boundary and “estimated” ending boundary is removed during a video editing operation. However, the above selection rule is not meant to be a limitation of the present invention. In general, the second timing range is determined to be within a neighborhood of the starting boundary of the sliding window corresponding to the leading shot number. As usual, the starting boundary of the sliding window is located at the center of the second timing range. For example, the second timing range comprises the starting boundary of the sliding window, 100 frame timings in front of the starting boundary of the sliding window, and 100 frame timings behind the starting boundary of the sliding window. However, the setting of 100 frame timings is not meant to be a limitation of the present invention. After the second timing range is determined, the ending boundary of the video segment (e.g. a commercial segment) is determined next (Step 190). In common, the ending boundary of the video segment is determined as a target timing (compared to the last frame timing) having a maximum luminance difference value corresponding to frames in the second timing range. In other embodiments, an audio discontinuity, for example a discontinuousness section of the volume, between a first specific frame and a second specific frame in the second timing range can also be utilized for determining the ending boundary of the video segment. In this situation, a frame timing corresponding to the first specific frame prior to the second specific frame is determined to be the ending boundary of the video segment. Finally, the method for estimating the boundary of the video segment is ended (Step 195).

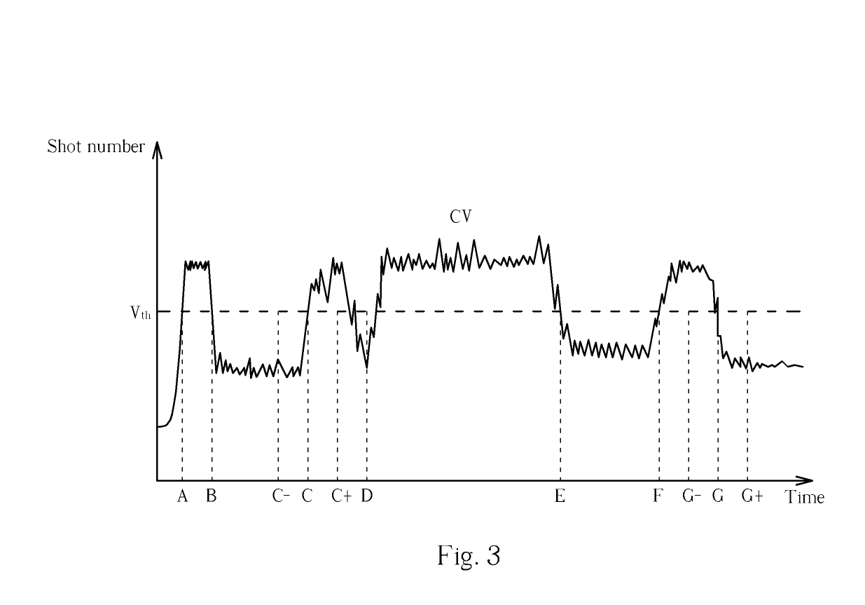

In order to clearly introduce technical features of the present invention, an example is given hereinafter to clearly detail the boundary estimation of the video segment. Please refer to FIG. 3. FIG. 3 is a diagram of an example illustrating the method for estimating the boundary of the video segment. In this example, a curve CV shown in FIG. 3 is generated from a plurality of shot numbers mentioned above through the sliding window. Although the curve CV shown in FIG. 3 is represented by a solid line, it is readily understood that the solid line is consisted of a plurality of dots each correspond to a shot number computed using the sliding window at a specific timing. As shown in FIG. 3, the curve CV at time A exceeds the predetermined threshold value Vₜₕ (i.e. 5); however, the curve CV at time B falls below the predetermined threshold value Vₜₕ. Since the first counter value accumulated during this period (from time A to time B) is not greater than the first threshold counter value (i.e. 50) and after time B the second counter value will reach the second threshold counter value (i.e. 5) before the first counter value reaches the first threshold counter value (i.e. 50), the first and second counter values are reset to respective initial values and then incremented by re-counting shot numbers that are greater/less than the predetermined threshold value Vₜₕ. That is to say, the first timing range is not determined yet.

As shown in FIG. 3, the curve CV at time C exceeds the predetermined threshold value Vₜₕ again. Although the curve CV in the neighborhood of time D is lower than the predetermined threshold value Vₜₕ, the shot numbers less than the predetermined threshold value Vₜₕ can be ignored since the first counter value will reach the first threshold counter value (i.e. 50) before the second counter value reaches the second threshold counter value (i.e. 5). Therefore the first timing range is determined according to the time C corresponding to an ending boundary of the sliding window. As mentioned above, the time C is usually located at the center of the first timing range. For example, the first timing range is a range from time C₋ to time C₊. In the following, the starting boundary of the video segment is determined according to a target timing (compared to the last timing) having a maximum luminance difference value corresponding to the frames within the first timing range C₋-C₊ or an audio discontinuity, and further description is not detailed here for brevity.

After the starting boundary of the video segment is estimated, the ending boundary of the video segment is to be determined. The curve CV at time E is lower than the predetermined threshold value Vₜₕ; however, the curve CV at time F is larger than the predetermined threshold value Vₜₕ again. The third counter value accumulated during this period (from time E to time F) is not greater than the third threshold counter value (i.e. 1000) and the curve CV shown in FIG. 3 will continue to exceed the predetermined threshold value from time F to time G where the fourth counter value accumulated during this period is greater the fourth threshold counter value (i.e. 30)). In other words, the fourth counter value reaches the fourth threshold counter value (i.e. 30) before the third counter value reaches the third threshold counter value (i.e. 1000). Therefore, both the third and fourth counter values are reset to respective initial values and then incremented by re-counting shot numbers that are greater/less than the predetermined threshold value Vₜₕ. It should be noted that the second timing range is not determined yet. After time G, the curve CV is continuously lower than the predetermined threshold value Vₜₕ, causing the third counter value to reach the third threshold counter value (i.e. 1000) before the fourth counter value reaches the fourth threshold counter value (i.e. 30), so the second timing range is determined according to the time G. As mentioned above, the time G is usually located at the center of the second timing range. For example, the second timing range is a range from time G₋ to time G₊. In the following, the ending boundary of the video segment is determined according to a target timing (compared to the last frame timing) having a maximum luminance difference value corresponding to the frames within the second timing range G₋-G₊ or an audio discontinuity, and further description is omitted here for brevity.

In another embodiment, it is allowable to directly determine the starting boundary of the video segment to be the ending boundary of the sliding window corresponding to the leading shot number of the 50 computed shot numbers, and to directly determine the ending boundary of the video segment to be the starting boundary of the sliding window corresponding to the leading shot number of the 1000 computed shot numbers, thereby reducing computation complexity. In this case, the Steps 140 and 145 for fine tuning the starting boundary and Steps 185 and 190 for fine tuning the ending boundary can be removed. Although the performance of the estimation using this way is not optimum, the same objective of identifying the boundary of the video segment (e.g. a commercial segment) is achieved. This also obeys the spirit of the present invention, and falls in the scope of the present invention. Similarly, in other embodiments, it is workable for directly determining the starting boundary of the video segment to be a frame timing corresponding to a shot number having been computed previously and being apart from the ending boundary of the sliding window corresponding to the leading shot number of the 50 computed shot numbers by a half size of the sliding window. Also it is feasible to directly determine the ending boundary of the video segment to be a frame timing corresponding to a shot number being not computed and apart from the starting boundary of the sliding window corresponding to the leading shot number of the 1000 computed shot numbers by a half size of the sliding window. The Steps for fine tuning the starting boundary and ending boundary of the commercial segment are removed and computation complexity is therefore reduced. Although the performance of the estimation using this way is not optimum, it is helpful to analyze a commercial segment since the commercial segment may exactly exist between the estimated starting and ending boundaries of the video segment.

Furthermore, in a particular embodiment applicable to an electronic apparatus having limited computing power, once a first shot number is greater than the predetermined threshold value, the starting boundary of the video segment can be directly determined to be the first specific timing (i.e., the ending boundary) of the sliding window corresponding to the first shot number. Similarly, once a second shot number generated later than the first shot number is not greater than the predetermined threshold value, the ending boundary of the video segment can be directly determined to be the second specific timing (i.e., the starting boundary) of the sliding window corresponding to the second shot number. In this way, the computation complexity is further reduced. Such an embodiment still obeys the spirit of the present invention.

In addition, in other embodiments, the above-mentioned scheme for counting counter values (i.e. Steps 115-130 and Steps 160-175) can be removed if counting counter values is regarded as an extra cost. Although the tolerance of varying shots occurring in the video segment becomes worse, the method for estimating the boundary of the video segment is still able to work with acceptable accuracy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for estimating a boundary of a video segment transmitted via an input multimedia stream, the method comprising the following steps:
utilizing a sliding window to calculate shots occurring in the input video stream for generating a plurality of shot numbers respectively; and
estimating the boundary according to the shot numbers and a predetermined threshold value.

2. The method of claim 1, wherein the step of estimating the boundary comprises:
comparing each of the shot numbers and the predetermined threshold value to generate a comparison result; and
estimating the boundary according to the comparison result.

3. The method of claim 2, wherein the step of estimating the boundary according to the comparison result comprises:
if a first shot number is greater than the predetermined threshold value, determining a starting boundary of the video segment to be a first specific timing of the sliding window corresponding to the first shot number.

4. The method of claim 3, wherein the first specific timing is an ending boundary of the sliding window corresponding to the first shot number.

5. The method of claim 3, wherein the step of estimating the boundary according to the comparison result further comprises:
if a second shot number generated later than the first shot number is not greater than the predetermined threshold value, determining an ending boundary of the video segment to be a second specific timing of the sliding window corresponding to the second shot number.

6. The method of claim 5, wherein the second specific timing is a starting boundary of the sliding window corresponding to the second shot number.

7. The method of claim 2, wherein the step of estimating the boundary according to the comparison result comprises:
if a plurality of first shot numbers are greater than the predetermined threshold value, determining a starting boundary of the video segment according to a first specific timing of the sliding window corresponding to a leading shot number of the first shot numbers.

8. The method of claim 7, wherein the first specific timing is an ending boundary of the sliding window corresponding to the leading shot number of the first shot numbers.

9. The method of claim 7, wherein the step of estimating the boundary according to the comparison result further comprises:
when the leading shot number is calculated, counting shot numbers greater than the predetermined threshold value to generate a first counter value;
wherein determining the starting boundary of the video segment to be the first specific timing is performed when the first counter value reaches a first threshold counter value.

10. The method of claim 9, wherein the step of estimating the boundary according to the comparison result further comprises:
when the leading shot number is calculated, counting shot numbers not greater than the predetermined threshold value to generate a second counter value; and
when the second counter value reaches a second threshold counter value before the first counter value reaches the first threshold counter value, resetting the first and second counter values and re-counting shot numbers that are greater than the predetermined threshold value.

11. The method of claim 7, wherein the step of determining the starting boundary of the video segment comprises:
determining a first timing range according to the first specific timing of the sliding window corresponding to the leading shot number of the first shot numbers; and
selecting a first target timing from the first timing range to be the starting boundary of the video segment.

12. The method of claim 11, wherein the step of selecting the first target timing comprises:
identifying an extreme value of shot numbers corresponding to frames in the first timing range; and
assigning a frame timing corresponding to the extreme value to be the first target timing.

13. The method of claim 11, wherein the step of selecting the first target timing comprises:
identifying an audio discontinuity between a first specific frame and a second specific frame in the first timing range; and
assigning a frame timing corresponding to the second specific frame next to the first specific frame to be the first target timing.

14. The method of claim 7, wherein the step of estimating the boundary according to the comparison result further comprises:
if a plurality of second shot numbers generated later than the first shot numbers are not greater than the predetermined threshold value, determining an ending boundary of the video segment according to a second specific timing of the sliding window corresponding to a leading shot number of the second shot numbers.

15. The method of claim 14, wherein the second specific timing is a starting boundary of the sliding window corresponding to the leading shot number of the second shot numbers.

16. The method of claim 14, wherein the step of estimating the boundary according to the comparison result further comprises:
when the leading shot number of the second shot numbers is calculated, counting shot numbers not greater than the predetermined threshold value to generate a third counter value;
wherein determining the ending boundary of the video segment to be the second specific timing is performed when the third counter value reaches a third threshold counter value.

17. The method of claim 16, wherein the step of estimating the boundary according to the comparison result further comprises:
when the leading shot number of the second shot numbers is calculated, counting shot numbers greater than the predetermined threshold value to generate a fourth counter value; and
when the fourth counter value reaches a fourth threshold counter value before the third counter value reaches the third threshold counter value, resetting the third and fourth counter values and re-counting shot numbers that are not greater than the predetermined threshold value.

18. The method of claim 14, wherein the step of determining the ending boundary of the video segment comprises:
determining a second timing range according to the second specific timing of the sliding window corresponding to the leading shot number of the second shot numbers; and
selecting a second target timing from the second timing range to be the ending boundary of the video segment.

19. The method of claim 18, wherein the step of selecting the second target timing comprises:
identifying an extreme value of shot numbers corresponding to frames in the second timing range; and
assigning a frame timing corresponding to the extreme value to be the second target timing.

20. The method of claim 18, wherein the step of selecting the second target timing comprises:
identifying an audio discontinuity between a first specific frame and a second specific frame in the second timing range; and
assigning a frame timing corresponding to the first specific frame prior to the second specific frame to be the second target timing.
